(19) United States
(12) Patent Application Publication
(10) Pub. No.: US 2009/0140678 A1
(43) Pub. Date: Jun. 4, 2009

(54) TORQUE RIPPLE SUPPRESSOR OF ENGINE

(76) Inventor: Kiyoharu Nakao, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/063,572

(22) PCT Filed: Jul. 20, 2006
(86) PCT No.: PCT/JP2006/314361

§ 371 Date: Feb. 11, 2008

(30) Foreign Application Priority Data
Aug. 12, 2005 (JP) 2005-234833

(51) Int. Cl. H02P 6/10

(52) U.S. Cl. 318/400.23

(57) ABSTRACT

A torque ripple suppressor (50) includes: an SR motor (20) coupled to an engine; a rotary position detector (24) that detects a rotary position of the SR motor (20); a pulse interval calculator (41) that calculates output interval of pulses output from the pulse interval calculator (24); an average pulse interval calculator (42) that calculates the average of calculated value of the pulse interval calculator (41); a pulse output state judging section (44) that judges whether the calculated value of the pulse interval calculator (41) is wider than the calculated vale of the average pulse interval calculator (42) or not, and a current controller (48) that controls motoring current or generating current of the SR motor (20) based on judgment of the pulse output state judging section (44).

### TECHNICAL FIELD

The present invention relates to a torque ripple suppressor that suppresses torque ripple of an engine coupled to an electric motor generator constituted by an SR (Switched Reluctance) motor.

### BACKGROUND ART

Vehicles of construction machines and automobiles and the like are normally equipped with a motor generator driven by an engine to provide electric power to peripheral equipments. Recent hybrid trend promotes development of vehicles equipped with an electric motor generator having a SR motor.

By the way, although it is seemed that an electric motor generator is driven by a constant number of engine revolutions, the number of revolutions slightly fluctuates in fact. This fluctuation is generated by torque fluctuations of an engine output shaft (hereinafter, torque ripple) including engine driving torque. The cycle of the fluctuation is decided by a number of fuel injection cylinders. For example, if it is a six-cylinder engine, 3 big torque fluctuations occur every 1 revolution of an engine output shaft since the six-cylinder engine has 3 combustion strokes per 1 revolution of the output shaft.

If this torque ripple is neglected, it develops as a cause of noise and vibration to the engine and a vehicle body. Therefore, the torque ripple is normally tried to be eliminated by increasing inertia of a flywheel.

On the other hand, another method is also suggested, which is to suppress the torque ripple by actively controlling torque of the electric motor generator directly coupled to the engine (for example, see Patent Document 1).

[Patent Document 1] JP-A-7-208228

### DISCLOSURE OF THE INVENTION

### Problems to be Solved by the Invention

However, according to Patent Document 1, torque ripple can only be suppressed during idling and scale of torque generated or absorbed by an electric motor generator cannot be controlled, which is therefore not sufficient to suppress torque ripple under various conditions.

An object of the present invention is to provide a torque ripple suppressor that effectively suppresses torque ripple of an engine coupled to an electric motor generator constituted by a SR motor.

### Means for Solving the Problems

According to an aspect of the present invention, a torque ripple suppressor of an engine includes: an SR motor coupled to the engine; a rotary position detector that detects a rotary position of the SR motor; a pulse interval calculator that calculates output interval of pulses output from the rotary position detector; an average pulse interval calculator that calculates the average of calculated values of the pulse interval calculator; a pulse output state judging section that judges whether the calculated value of the pulse interval calculator is wider than the calculated value of the average pulse interval calculator or not, and a current controller that controls motoring current or generating current of the SR motor based on judgment of the pulse output state judging section.

Such an aspect can effectively suppress torque ripple under various conditions since the torque ripple is always detected and current amount of the SR motor is actively controlled according to the variation of the torque ripple. Further, a flywheel of the engine can accordingly be lightweighted to improve response upon changing rotation speed of the engine, which consequently reduces fuel consumption. In addition, since an SR motor is applied as an electric motor generator, the configuration can be more compact than before while keeping a conventional volume of output.

In the torque ripple suppressor of the above arrangement, the current controller preferably increases the motoring current of the SR motor when it is judged that the calculated value of the pulse interval calculator is wider than the calculated value of the average pulse interval calculator and decreases the motoring current of the SR motor when it is judged that the calculated value of the pulse interval calculator is smaller than the calculated value of the average pulse interval calculator when the SR motor is in motoring mode.

Accordingly, torque ripple of which an engine is especially heavily loaded can be actively controlled since current flowed through the SR motor in motoring mode can be regulated.

In the torque ripple suppressor of the above arrangement, the current controller preferably decreases the generating current of the SR motor when it is judged that the calculated value of the pulse interval calculator is wider than the calculated value of the average pulse interval calculator and increases the generating current of the SR motor when the calculated value of the pulse interval calculator is smaller than the calculated value of the average pulse interval calculator when the SR motor is in generating mode.

Accordingly, torque ripple can be actively controlled when the SR motor is in generating mode that is relatively frequently used as an electric motor generator since current flowed through the SR motor in generating mode can be regulated.

In the above arrangement, the torque ripple suppressor may preferably further include a pulse interval deviation storage that stores a deviation between the calculated value of the pulse interval calculator and the calculated value of the average pulse interval calculator by each pulse, in which the deviation stored in the pulse interval deviation storage is updated by at least one revolution of the SR motor.

Accordingly, the relation between the cycle of torque ripple and the rotary position of a rotor can be kept constant since the stored value of the deviation between each pulse output interval and the average is updated by at least one revolution of the SR motor.

### BRIEF DESCRIPTION OF DRAWINGS

FIG. 1 is a plan view showing an electric rotary excavator having a torque ripple suppressor of an embodiment of the present invention.

FIG. 2 is a schematic illustration showing an arrangement around a SR motor constituting the torque ripple suppressor of the embodiment.

FIG. 3 is a block diagram showing a control structure of a controller of the embodiment.

FIG. 4 is an illustration showing a pulse output of a rotary position detector of the embodiment.

FIG. 5 is an illustration showing a torque condition when the SR motor of the embodiment is in motoring mode.

FIG. 6 is an illustration showing a torque condition when the SR motor of the embodiment is in generating mode.

FIG. 7 is an illustration showing a torque condition when the SR motor of the embodiment is unloaded.

FIG. 8 is a flow chart showing a control flow when the torque ripple suppressor of the embodiment is in motoring mode.

FIG. 9 is a flow chart showing a control flow when the torque ripple suppressor of the embodiment is in generating mode.

FIG. 10 is a flow chart showing a control flow when the torque ripple suppressor of the embodiment is unloaded.

### EXPLANATION OF CODES

11 . . . engine, 20 . . . SR motor, 24 . . . rotary position detector, 41 . . . pulse interval calculator, 42 . . . average pulse interval calculator, 43 . . . pulse interval deviation storage, 44 . . . pulse output state judging section, 48 . . . current controller, 50 . . . torque ripple suppressor

### BEST MODE FOR CARRYING OUT THE INVENTION

### Overall Arrangement

An embodiment of the present invention will be described below with reference to the accompanying drawings.

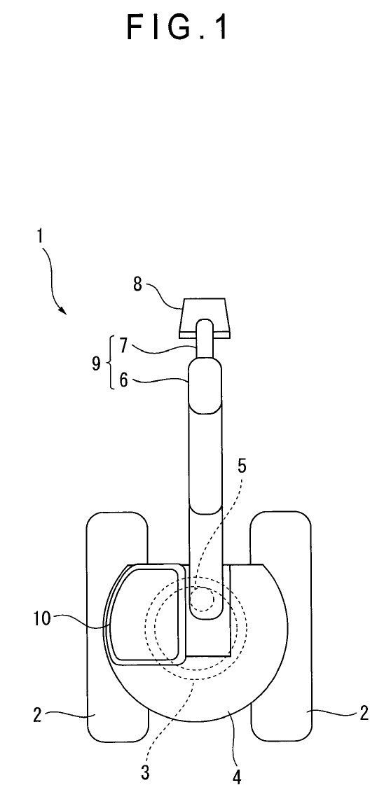

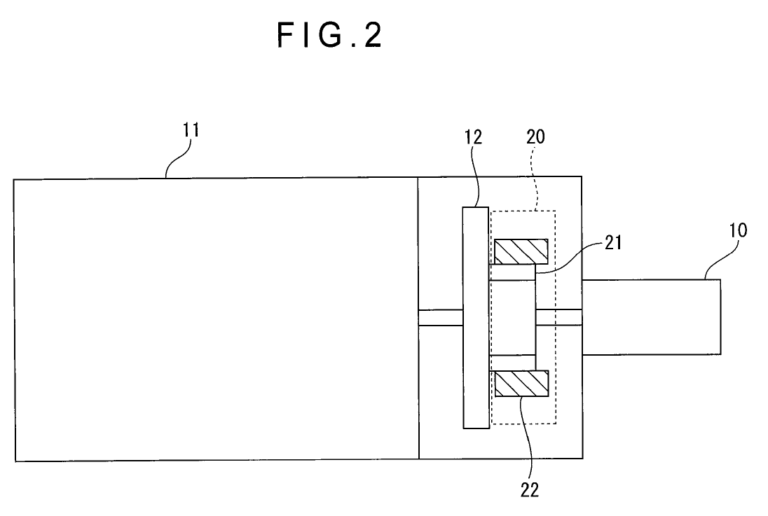

FIG. 1 is a plan view showing an electric rotary excavator 1 having a torque ripple suppressor 50 of the present embodiment. FIG. 2 is a schematic illustration showing an arrangement around a SR motor 20 constituting the torque ripple suppressor 50 of the present embodiment.

In FIG. 1, the electric rotary excavator 1 includes a rotary body 4 provided via a swing circle 3 on a truck frame that constitutes a base carrier 2. The rotary body 4 is rotated by an electric motor 5 that meshes with the swing circle 3.

The rotary body 4 is provided with a boom 6, an arm 7 and a bucket 8 respectively operated by hydraulic cylinders (not shown), which constitute a working equipment 9. Pressure oil to each of the hydraulic cylinders is supplied by a hydraulic pump 10 (see FIG. 2) equipped with the rotary body 4. Accordingly, the electric rotary excavator 1 is a hybrid construction machine equipped with the working equipment 9 and the electrically driven rotary body 4.

In FIG. 2, the rotary body 4 is equipped with an engine 11. The SR motor 20 and the hydraulic pump 10 are coaxially coupled to the engine 11 via a flywheel 12.

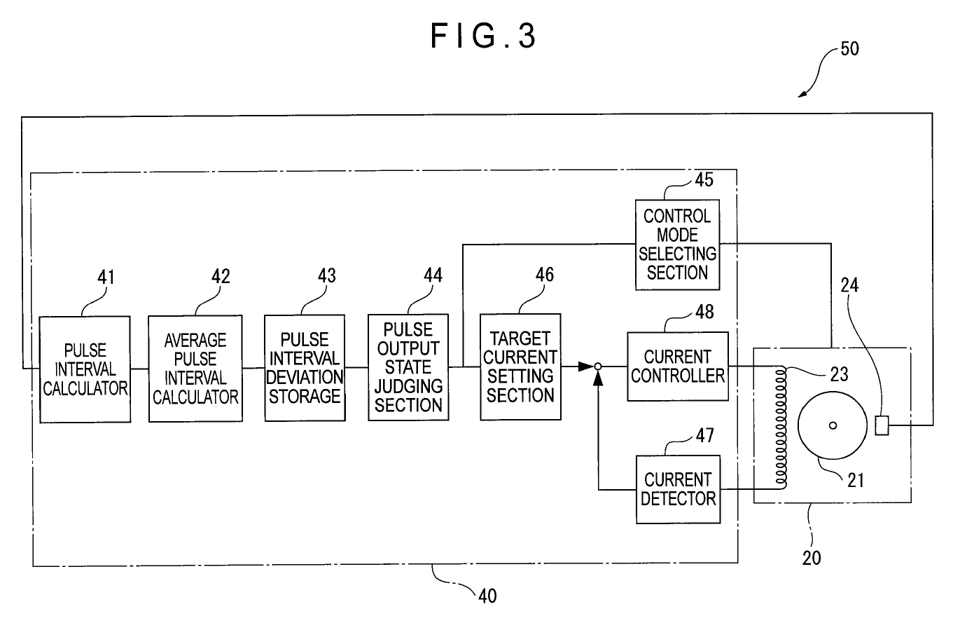

The SR motor 20 is an electric motor generator controlled by a controller 40 shown in FIG. 3, which has a function of an electric motor assisting the engine 11 while also having a function of an electric generator distributing electric power to the electric motor 5. The torque ripple suppressor 50 of the present invention includes the SR motor 20 and the controller 40.

Further, although not shown, an electric storage device such as a capacitor that is a source of electric power distribution is also connected to the SR motor 20.

The SR motor 20 is provided with a rotatable rotor 21 centrally placed and an annular stator 22 that surrounds the rotor 21. The rotor 21 is mounted on the flywheel 12 on an output shaft of the engine 11 to be directly connected to the engine 11. The stator 22 has a plurality of poles that correspond to a plurality of coils 23 (only one of them is schematically shown in FIG. 3) wound around the stator 22. So-called three-phase current of different phases is flowed through the coils 23 to excite the stator 22 to rotate the rotor 21.

In the present embodiment, the number of poles of the rotor 21 and the stator 22 is respectively 16 and 24. The torque control resolution is 48 divisions per one revolution. A different torque can be set by every 7.5 degrees.

Further, the SR motor 20 has an advantage that the driving circuit is immune from damages since the SR motor 20 normally does not generate electric power under non-excited condition when the rotor 21 and the engine 11 are rotated together so that no voltage is imposed on the high-voltage line when the driving circuit is not energized.

On stator poles of the stator 22, a total of three (one for each phase) rotary position detectors 24 (see FIG. 3) constituted by a Hall sensor for controlling an angle of advance and the like are provided. A sensor dedicated for torque ripple suppression is not necessary to be separately provided since torque ripple is suppressed by the rotary position detectors 24. In the present embodiment, a Hall sensor is applied to the rotary position detectors 24 which detects a position of the rotor 21 by a combination with a magnet (not shown) provided on a salient pole of the rotor 21. As the rotary position detector 24, in addition to the above, a method using a combination of a photo interrupter and a slit can be applied.

The controller 40 is a device for controlling a drive of the SR motor 20, which controls an angle of advance of the SR motor 20, switches control modes between a motoring mode and a generating mode and regulates motoring current and generating current based on a torque command from a generation control section (not shown) and a pulse output from the rotary position detector 24. By these operations, the controller 40 controls motoring torque or generating torque of the SR motor 20. In addition, the controller 40 can control torque of each pole regardless of whether the SR motor 20 is in motoring mode or generating mode.

Accordingly, torque ripple can be suppressed by regulating the phase and the amount of motoring current or generating current of the SR motor 20 so that the controller 40 is directed to offset the torque ripple. Thus, the torque control resolution of the SR motor 20 is finely set to an extent that can correspond to a generation cycle of a torque ripple decided mainly by a number of fuel injection cylinders of the engine 11. If such a setting has not been established, torque ripple can not be sufficiently suppressed or rather likely to be promoted.

In the SR motor 20 of the present embodiment, a different torque can be set by every 7.5 degrees as mentioned above. This resolution can correspond to any number (i.e. four, six, eight or twelve) of fuel injection cylinders of the engine 11. Further, such a fine torque control resolution can suppress torque ripple including not only the one by the engine 11 but also the one by the hydraulic pump 10.

### [Control Structure of Torque Ripple Suppressor]

Next, a control structure of the torque ripple suppressor 50 will be described so that the arrangement of the controller 40 is especially detailed.

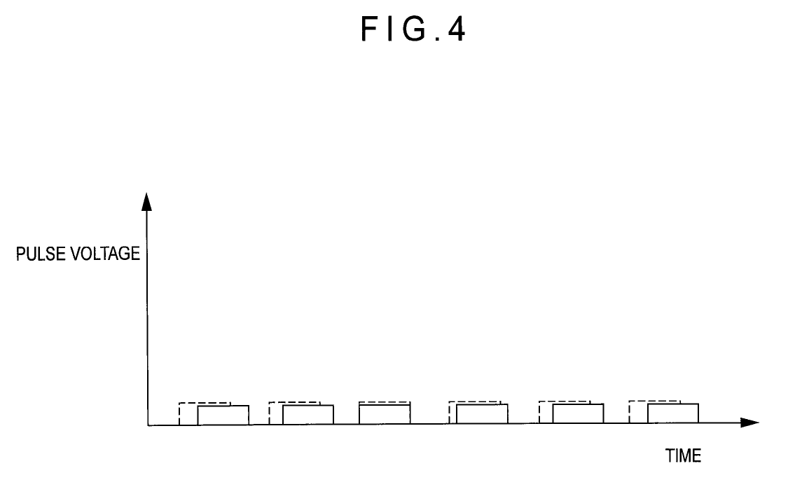

FIG. 3 is a block diagram showing the control structure of the controller 40 of the present embodiment. FIG. 4 is a figure showing a pulse output of the rotary position detector 24.

In FIG. 3, the controller 40 is provided with a pulse interval calculator 41, an average pulse interval calculator 42, a pulse interval deviation storage 43, a pulse output state judging section 44, a control mode selecting section 45, a target current setting section 46, a current detector 47 and a current controller 48, which are constituted by unprescribed hardware or software.

The pulse interval calculator 41 calculates output intervals of the pulse signal from the rotary position detector 24. The rotary position detector 24 detects the rotary position of the rotor 21 by each phase and outputs the pulse signal. Accordingly, 16 pulses are output for each phase of the stator 22 per one revolution of the rotor. These pulses are normally tend to be spaced at different intervals by torque ripple (see the full line in FIG. 4) rather than being spaced at constant intervals as shown in FIG. 4. When torque ripple of the output shaft of the engine 11 is wider than the average, the output pulse interval of the rotary position detector 24 becomes narrower. On the other hand, torque ripple of the output shaft of the engine 11 is narrower than the average, the output pulse interval becomes wider. Accordingly, torque ripple can be detected by detecting fluctuations of the output intervals. In addition, the dash line in FIG. 4 is the pulse output of the rotary position detector 24 when the rotation speed is constant. When there is no torque ripple, the constant intervals are kept in this way.

The average pulse interval calculator 42 calculates the average of pulse output intervals per one revolution of the rotor using the output intervals of each pulse calculated by the pulse interval calculator 41. In the SR motor 20 of the present embodiment, one revolution of the rotor can be divided into 48 as mentioned above. However, since the actual control is separately done for each phase, calculation of the average is separately done for each phase using data of the pulse output intervals of the 16 pulses.

The pulse interval deviation storage 43 stores the deviation between each pulse interval calculated by the pulse interval calculator 41 and the average of the pulse output intervals calculated by the average pulse interval calculator 42. Since the cycle of torque ripple is mainly decided by the number of fuel injection cylinders of the engine, the relation between the cycle of torque ripple and the rotary position of the rotor 21 can be always kept constant when a control data is to be updated by every one revolution of the rotor. Consequently, the above-mentioned deviation of each pulse for one revolution of the rotor, specifically 16 data per each phase, 48 data in total is stored in the pulse interval deviation storage 43.

The pulse output state judging section 44 judges whether the sign of the above-mentioned deviation stored in the pulse interval deviation storage 43 (i.e. each pulse interval calculated by the pulse interval calculator 41) is wider than the average of the pulse output intervals calculated by the average pulse interval calculator 42, specifically judging the sign of the above-mentioned deviation stored in the pulse interval deviation storage 43.

The control mode selecting section 45 switches a control mode of the SR motor 20 to motoring mode or to generating mode. Switching of the control mode during operations is mainly done based on a torque command from the generation control section (not shown). However, when the engine 11 drives only the hydraulic pump 10 without normal power generation of the SR motor 20 and when the SR motor 20 is unloaded such as during idling of the engine 11, the switching is done based on the judgment of the pulse output state judging section 44. In this case, when the sign of the above-mentioned deviation is plus according to the judgment of the pulse output state judging section 44, the control mode selecting section 45 switches the mode of the SR motor 20 to motoring mode. When the sign of the above-mentioned deviation is minus, the control mode selecting section 45 switches the mode of the SR motor 20 to generating mode.

The target current setting section 46 sets a target value of motoring current or generating current flowed through the coils 23 based on the torque command from the generation control section (not shown), the above-mentioned deviation stored in the pulse interval deviation storage 43 and the judgment of the pulse output state judging section 44. Accordingly, scale of torque ripple is reflected to the setting of the target current. Amount of motoring current or generating current flowed through the coils 23 consequently increases or decreases according to the scale of torque ripple. Although an electric motor generator is tend to be functioned as a generator, in this case, the electric motor generator is set so that generating torque of the SR motor 20, i.e. generating current flowed through the coils 23, is maximized near the maximum torque of the engine 11 and generating current is limited near the minimum torque of the engine 11.

The current detector 47 is constituted by a current sensor and the like to detect the current value actually flowed through the coils 23 and feed back the value to the current controller 48.

The current controller 48 controls the amount of the current flowed through the stator poles based on the target current set by the target current setting section 46 and the actual current value fed back from the current detector 47. Specifically, the current controller 48 includes a circuit that adjusts the amount of generating current or generating current flowed through the coils 23 by switching of PWM (Pulse Width Modulation) control.

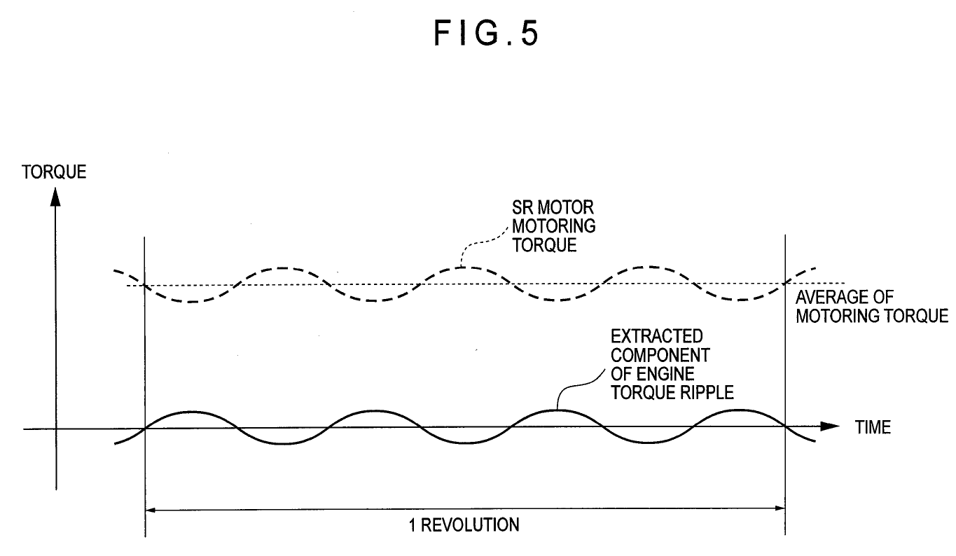

For example, the current controller 48 increases or decreases the amount of motoring current according to the above-described deviation when the SR motor 20 is in motoring mode as shown in FIG. 5. Accordingly, scale of the motoring torque of the SR motor 20 added to the motoring torque of the engine 11 is changed.

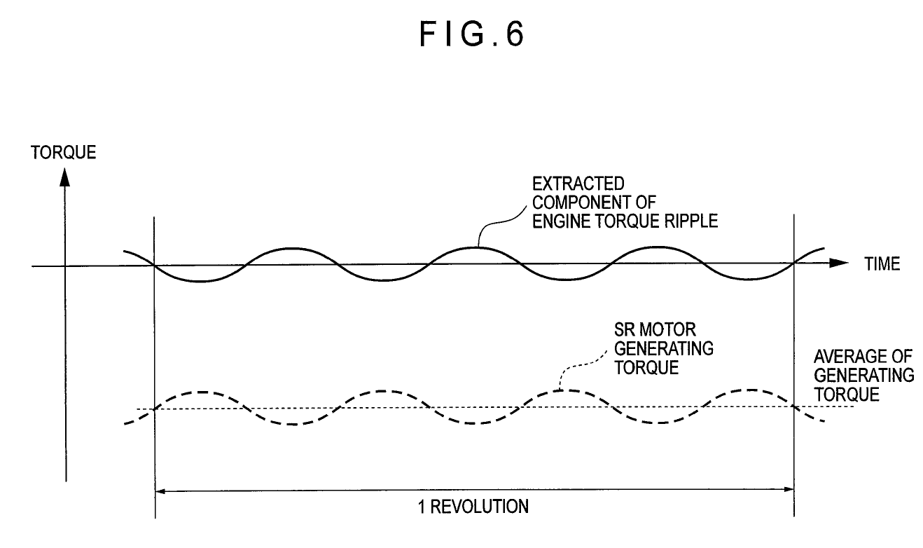

On the other hand, the current controller 48 increases or decreases the amount of generating current according to the above-described deviation when the SR motor 20 is in generating mode as shown in FIG. 6. Accordingly, scale of the generating torque of the SR motor 20 (the scale of the torque absorption of the engine 11) is changed.

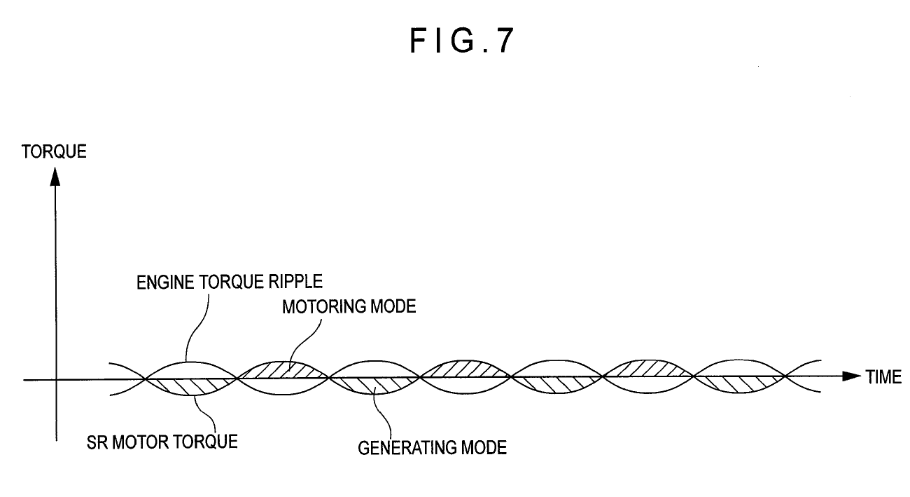

Further, when the SR motor 20 is unloaded as shown in FIG. 7, the torque is too low if the sign of the above-mentioned deviation is plus according to the judgment of the pulse output state judging section 44. The current controller 48 pursuantly increases the amount of motoring current according to the above-mentioned deviation so that the torque is added up. If the sign of the above-mentioned deviation is minus, the current controller 48 increases the amount of the generating current according to the above-mentioned deviation to generate the superfluous torque since the torque is too high.

### [Control Flow of Torque Ripple Suppressor]

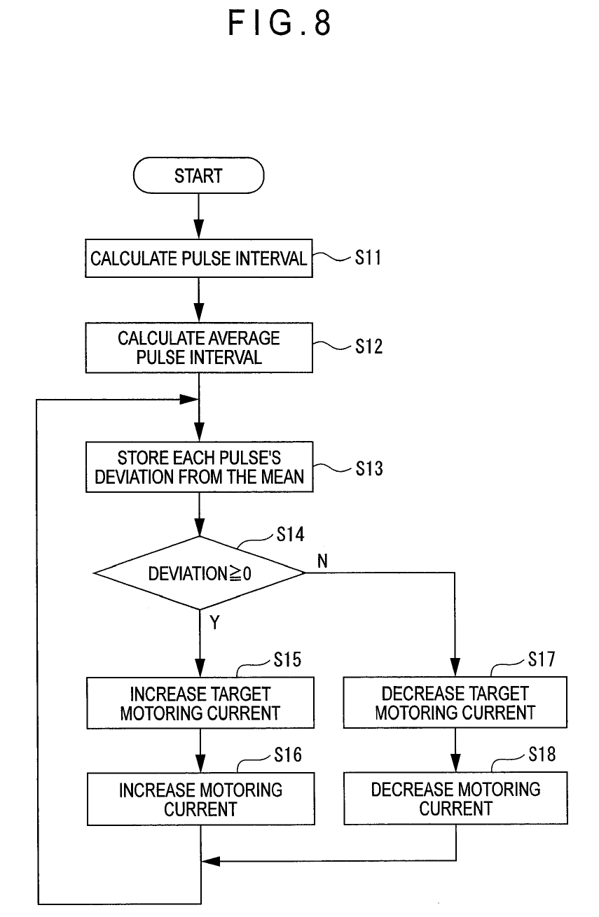

Next, a control flow of the torque ripple suppressor using the controller 40 will be described below with reference to FIGS. 8 to 10.

Firstly, a control flow when the SR motor 20 is in motoring mode will be described with reference to FIG. 8. This falls on a case where the SR motor 20 assists the drive of the engine 11 since the hydraulic pump 10 is heavily loaded.

The pulse interval calculator 41 calculates output interval of pulse signal from the rotary position detector 24 (Step 11: “Step” is simply abbreviated as “S” in Figs. and the following explanations).

The average pulse interval calculator 42 calculates the average of pulse output intervals of the 16 pulses that are of one revolution of the rotor per one phase using the output intervals of each pulse calculated by the pulse interval calculator 41 (S12).

The pulse interval deviation storage 43 stores data that is of one revolution of the rotor as for the deviation between each pulse interval calculated by the pulse interval calculator 41 and the average of the pulse output intervals calculated by the average pulse interval calculator 42 (S13).

The pulse output state judging section 44 judges the sign of the above-mentioned deviation stored in the pulse interval deviation storage 43 (S14).

When the sign is plus, the target current setting section 46 increases a target value of motoring current flowed through the coils 23 based on the above-mentioned deviation (S15). Accordingly, the current controller 48 increases motoring current flowed through the coils 23 according to the above-mentioned deviation (S16). On the other hand, when the sign is minus, the target current setting section 46 decreases a target value of motoring current flowed through the coils 23 based on the above-mentioned deviation (S17). Accordingly, the current controller 48 decreases motoring current flowed through the coils 23 according to the above-mentioned deviation (S18).

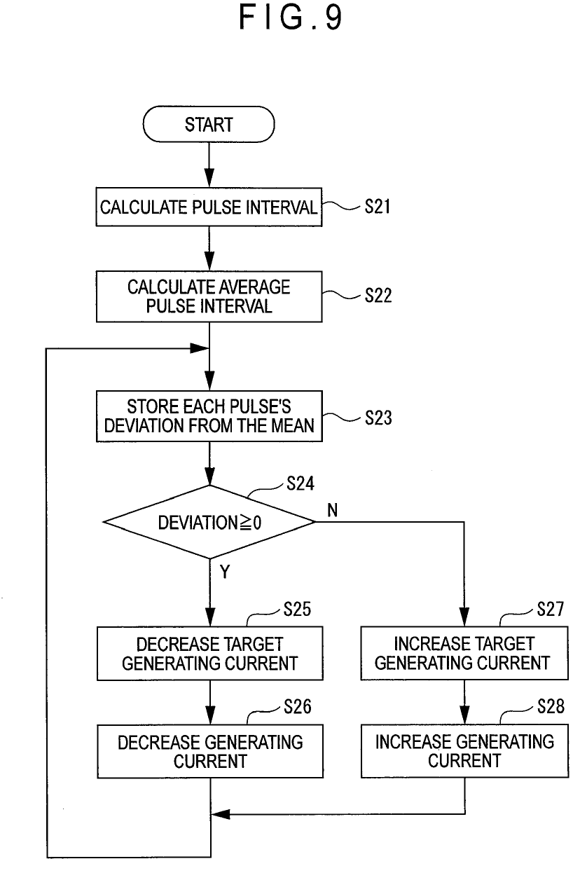

Next, a control flow when the SR motor 20 is in generating mode will be described with reference to FIG. 9.

The control flow when the SR motor 20 is functioned in generating mode is exactly the same as the flow when the SR motor 20 is in motoring mode except that the process of the current controller 48 with respect to the judgment of the pulse output state judging section 44 is different. In other words, S21-S24 are the same as the control flow S11-S14 when the SR motor 20 is in motoring mode. Therefore, the explanation will be omitted.

When the above-mentioned sign of the deviation is plus according to the judgment of the pulse output state judging section 44, the target current setting section 46 decreases a target value of generating current flowed through the coils 23 based on the above-mentioned deviation (S25). Accordingly, the current controller 48 decreases generating current flowed through the coils 23 according to the above-mentioned deviation (S26). On the other hand, when the sign is minus, the target current setting section 46 increases a target value of generating current flowed through the coils 23 based on the above-mentioned deviation (S27). Accordingly, the current controller 48 increases generating current flowed through the coils 23 according to the above-mentioned deviation (S28).

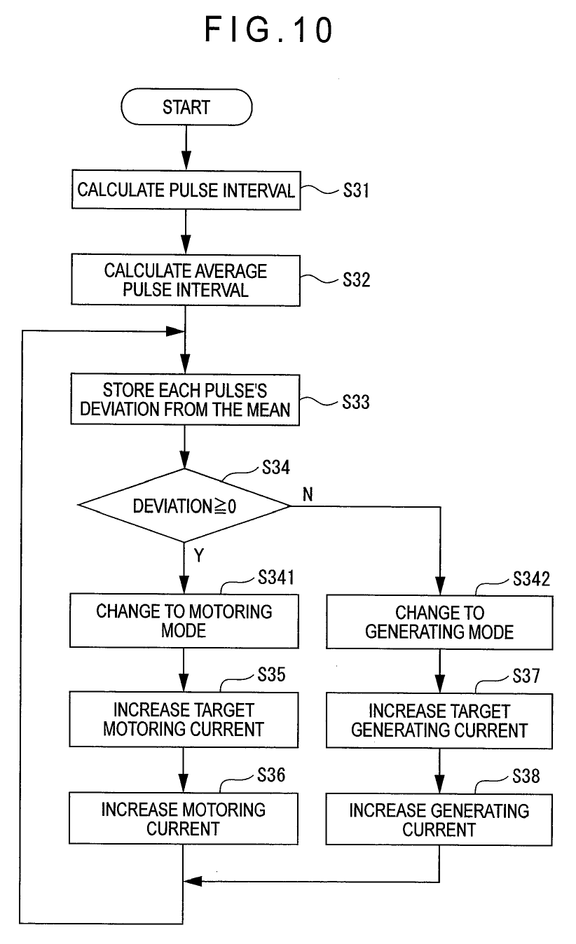

Next, a control flow when the SR motor 20 is unloaded will be described with reference to FIG. 10. When the SR motor 20 does not generate electric power and does not assist driving of the engine 11 either (i.e. when the engine 11 drives only the hydraulic pump 10), the SR motor 20 is switched to generating mode to absorb the torque and decrease the rotation if the engine torque is higher than the average torque: On the other hand, the SR motor 20 is functioned in motoring mode to add the torque and increase the rotation if the engine torque is lower than the average.

The control flow when the SR motor 20 is unloaded is also the same as the flow when the SR motor 20 is in motoring mode or generating mode. However, in this case, what is different is that the control mode selecting section 45 switches the control mode of the SR motor 20 to generating mode or motoring mode based on the judgment of the pulse output state judging section 44 in addition to the difference of the process of the current controller 48 according to the judgment of the pulse output state judging section 44. In other words, S31-S34 are the same as the control flow S11-S14 or S21-S24 when the SR motor 20 is functioned in generating mode or motoring mode. Therefore, the explanation will be omitted.

When the above-mentioned sign of the deviation is plus according to the judgment of the pulse output state judging section 44, the control mode selecting section 45 switches the control mode of the SR motor 20 to motoring mode (S341). Accordingly, the target current setting section 46 increases the target value of motoring current flowed through the coils 23 (S35) so that the current controller 48 increases the motoring current flowed through the coils 23 (S36). On the other hand, when the sign is minus, the control mode selecting section 45 switches the control mode of the SR motor 20 to generating mode (S342). Accordingly, the target current setting section 46 increases the target value of generating current flowed through the coils 23 (S37) so that the current controller 48 increases the generating current flowed through the coils 23 (S38).

It should be noted that the present invention is not limited to the embodiments described above, but encompasses other arrangements or the like that can achieve an object of the present invention, and also includes modifications as shown below.

For example, although the SR motor 20 is regulated by current control in the above embodiment, it may be regulated by torque control. In such a case, a part of the controller 40 is required to be adapted to the torque control such that, for example, the target current setting section 46 is replaced with a target torque setting section.

Further, although the average pulse interval calculator 42 calculates the average value of the pulse output intervals per one revolution of the rotor in the above embodiment, it may be the average of the intervals per two revolutions.

Although the best arrangement and method for implementing the present invention has been disclosed above, the present invention is not limited thereto. In other words, the present invention is mainly illustrated and described on the specific embodiment, however, a person skilled in the art can modify the specific configuration as long as a technical idea and an object of the present invention can be achieved.

### INDUSTRIAL APPLICABILITY

The present invention can be applied to any kind of construction machines in which an electric motor generator coupled to an engine is provided and the SR motor is used as the electric motor generator.

1. A torque ripple suppressor of an engine, comprising:
an SR motor coupled to the engine;
a rotary position detector that detects a rotary position of the SR motor;
a pulse interval calculator that calculates output interval of pulses output from the rotary position detector;
an average pulse interval calculator that calculates an average of calculated values of the pulse interval calculator;
a pulse output state judging section that judges whether the calculated value of the pulse interval calculator is wider than the calculated value of the average pulse interval calculator or not, and
a current controller that controls motoring current or generating current of the SR motor based on judgment of the pulse output state judging section.

2. The torque ripple suppressor according to claim 1,
wherein the current controller increases the motoring current of the SR motor when it is judged that the calculated value of the pulse interval calculator is wider than the calculated value of the average pulse interval calculator and decreases the motoring current of the SR motor when it is judged that the calculated value of the pulse interval calculator is narrower than the calculated value of the average pulse interval calculator, while the SR motor is in motoring mode.

3. The torque ripple suppressor according to claim 1,
wherein the current controller decreases the generating current of the SR motor when it is judged that the calculated value of the pulse interval calculator is wider than the calculated value of the average pulse interval calculator and increases the generating current of the SR motor when the calculated value of the pulse interval calculator is narrower than the calculated value of the average pulse interval calculator, while the SR motor is in generating mode.

4. The torque ripple suppressor according to claim 2, further comprising
a pulse interval deviation storage that stores a deviation between the calculated value of the pulse interval calculator and the calculated value of the average pulse interval calculator by each pulse, wherein
the deviation stored in the pulse interval deviation storage is updated by at least one revolution of the SR motor.

5. The torque ripple suppressor according to claim 3, further comprising
a pulse interval deviation storage that stores a deviation between the calculated value of the pulse interval calculator and the calculated value of the average pulse interval calculator by each pulse, wherein
the deviation stored in the pulse interval deviation storage is updated by at least one revolution of the SR motor.
